(19) United States
(12) Patent Application Publication
(10) Pub. No.: US 2020/0016621 A1
(43) Pub. Date: Jan. 16, 2020

(54) GARDEN SPRINKLER SECURING STRUCTURE

(71) Applicant: SHIN TAI SPURT WATER OF THE GARDEN TOOLS CO., LTD., Lu-Kang Town (TW)

(72) Inventor: Chin-Yuan Chen, LU-KANG TOWN (TW)

(21) Appl. No.: 16/246,459

(22) Filed: Jan. 12, 2019

(30) Foreign Application Priority Data
Jul. 12, 2018 (TW) 107209421

(51) Int. Cl. B05B 15/622

(52) U.S. Cl. CPC B05B 15/622; B05B 3/06

(57) ABSTRACT

A garden sprinkler securing structure has two base members, and one of the base members has an input opening and an output opening. The input opening is configured to connect to a water source, and the output opening is provided with a sprinkler pivoted between the two base members. When water from the water source enters the input opening to drive the sprinkler to repeatedly swing between the base members. The two base members respectively further have two supporting legs at opposite sides, a bottom side of each supporting leg engages with a connecting member, and the connecting member is pivoted with a grounding nail. An outer side of each supporting leg of the base members is provided with a containment space at a bottom side, and the containment space is configured for accepting the engaged connecting member.

### BACKGROUND OF INVENTION

### 1. Field of Invention

The present invention relates to a garden sprinkler securing structure, and more particularly to a garden sprinkler securing structure utilizing the grounding nails.

### 2. Description of the Related Art

In the horticultural work, the flowers and trees need to be watered frequently to avoid the plants from dying due to lack of water. When spraying for a wide range of long time, the sprinklers or the sprinkle are often used. Since the common sprinklers can only be placed on the ground when used, the simple placement has no firm positioning, so it is easy to sprinkler displacement issue during the spraying process.

Therefore, it is desirable to provide a garden sprinkler securing structure to mitigate and/or obviate the aforementioned problems.

### SUMMARY OF THE INVENTION

An objective of present invention is to provide a garden sprinkler securing structure has two base members, and one of the base members has an input opening and an output opening. The input opening is configured to connect to a water source, and the output opening is provided with a sprinkler pivoted between the two base members. When water from the water source enters the input opening to drive the sprinkler to repeatedly swing between the base members. The two base members respectively further have two supporting legs at opposite sides, a bottom side of each supporting leg engages with a connecting member, and the connecting member is pivoted with a grounding nail. An outer side of each supporting leg of the base members is provided with a containment space at a bottom side, and the containment space is configured for accepting the engaged connecting member. The connecting member is further provided with a slot having the grounding nail pivoted adjacent to the outer side of each supporting leg, therefore, the grounding nail can be rotated out toward the outer side or stored in the slot.

Other objects, advantages, and novel features of invention will become more apparent from the following detailed description when taken in conjunction with the accompanying drawings.

### BRIEF DESCRIPTION OF DRAWINGS

FIG. 1 is a three-dimensional combination according to a preferred embodiment of the present invention.

FIG. 2 is a three-dimensional exploded view according to the preferred embodiment of the present invention.

FIG. 3 is a state diagram of the grounding nail secured into the ground according to the preferred embodiment of the present invention.

FIG. 4 shows the spray process after the grounding nail is secured according to the preferred embodiment of the present invention.

FIG. 5 shows the grounding nail being folded according to the preferred embodiment of the present invention.

FIG. 6 shows the stored grounding nail after the completion of the fold. according to the preferred embodiment of the present invention.

### DETAILED DESCRIPTION OF THE PREFERRED EMBODIMENT

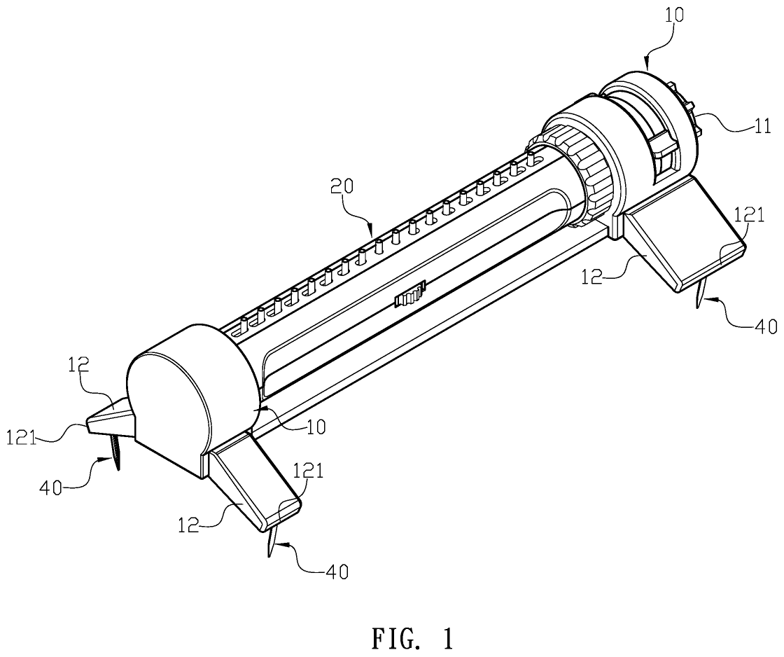

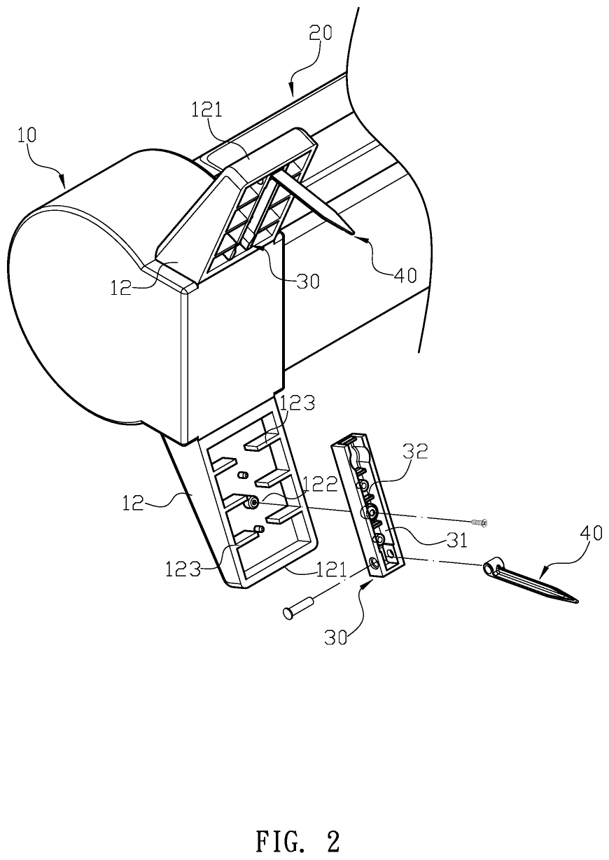

As shown in FIG. 1 and FIG. 2, a garden sprinkler securing structure comprises two base members 10, and one of the base members has an input opening 11 and an output opening 12. The input opening 11 is configured to connect to a water source, and the output opening 12 is provided with a sprinkler 20 pivoted between the two base members 10. When water from the water source enters the input opening 11 to drive the sprinkler 20 to repeatedly swing between the base members 10. The two base members 10 respectively further have two supporting legs 12 at opposite sides, a bottom side of each supporting leg 12 engages with a connecting member 30, and the connecting member 30 is pivoted with a grounding nail 40. An outer side 121 of each supporting leg 12 of the base members 10 is provided with a containment space 122 at a bottom side, and the containment space 122 is configured for accepting the engaged connecting member 30. The connecting member 30 is further provided with a slot 31 having the grounding nail 40 pivoted adjacent to the outer side 121 of each supporting leg 12, therefore, the grounding nail 40 can be rotated out toward the outer side 121 or stored in the slot 31.

In the preferred embodiment of the present invention, the two base members 10 are integrated.

In the preferred embodiment of the present invention, the supporting leg 12 extends out the base member 10 and tilts down from the base member.

In the preferred embodiment of the present invention, the supporting leg 12 extends horizontally.

In the preferred embodiment of the present invention, the containment space 122 further has a positioning member 123 disposed at two sides of the connecting member 30, for securing the connecting member 30 in the containment space 122.

In the preferred embodiment of the present invention, the connecting member 30 is stored in the containment space 122 and then locked with the containment space 122.

In the preferred embodiment of the present invention, the slot 31 further has at least one supporting member 32 for securing the grounding nail 40.

In the preferred embodiment of the present invention, the grounding nail 40 has a sharp end and a protruding strip.

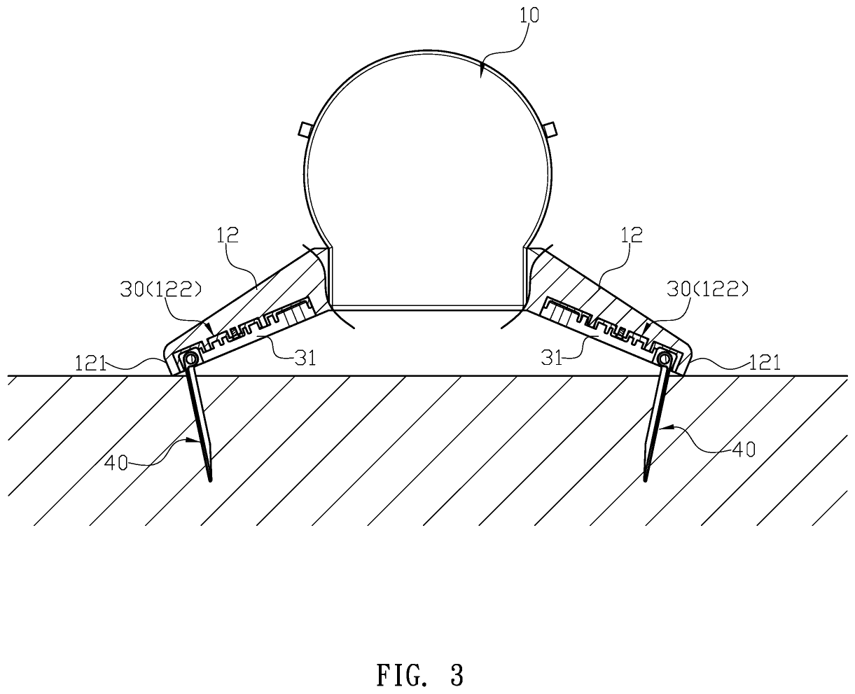

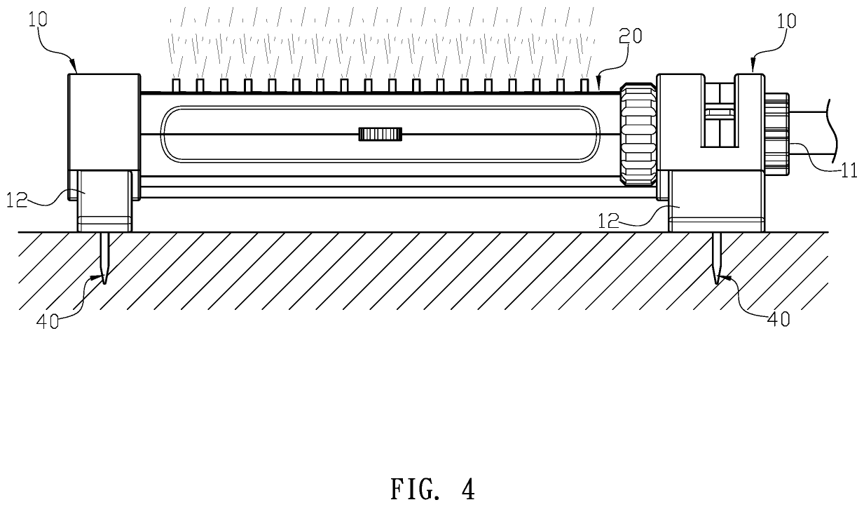

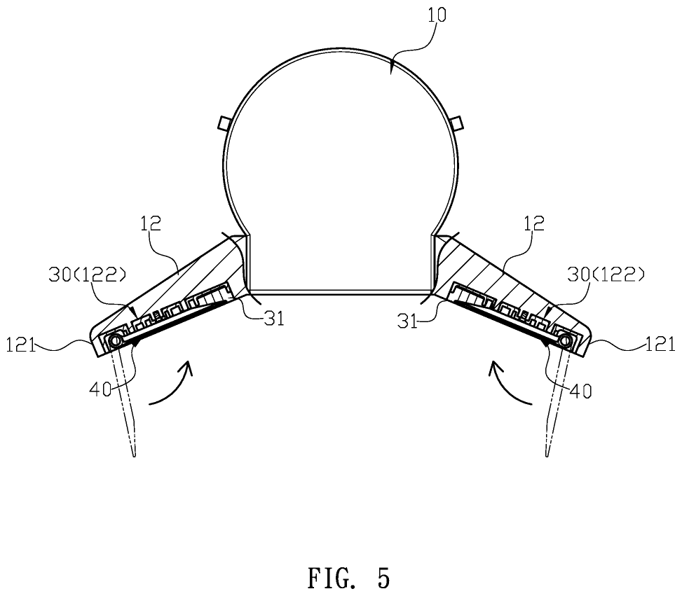

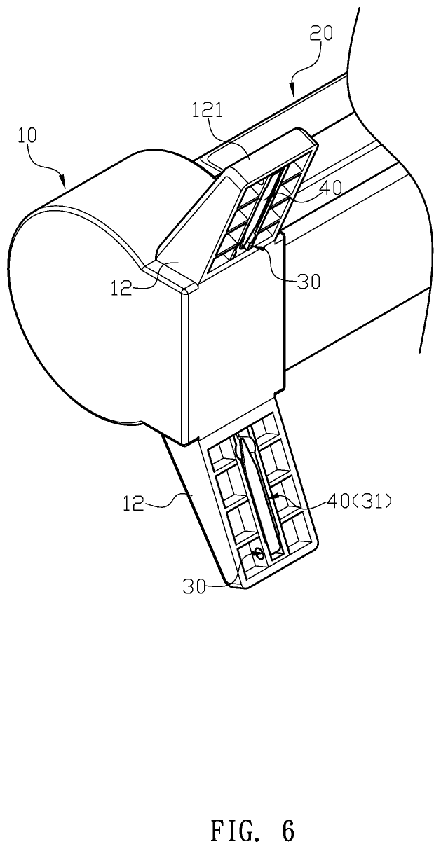

As shown in FIGS. 3 and 4, for the actual use, the grounding nail 40 that rotated out from the slot 31 is insert into the ground, so that the base member 10 and the sprinkle 20 are placed on the ground with solid positioning, avoiding the sprinkle 20 from moving or tilting during the spraying process. Furthermore, the grounding nail 40 extends widely and provides further length. When the sprinkle 20 is not in use, the grounding nail 40 is pulled out of the ground and then folded into the slot 31. Please also be shown in FIG. 5 and FIG. 6, when the sprinkle 20 is not in use, folding the grounding nail 40, can avoid injury. The connecting member 30 allows the grounding nail 40 being pivoted, and the engagement of the connecting member 30 the grounding nail 40 is stored into the containment space 122 for simplifying the difficulty of disassembly and assembly of the grounding nail 40. Therefore, the grounding nail 40 can be installed more easily or can be easily replaced if it is damaged.

Although the present invention has been explained in relation to its preferred embodiment, it is to be understood that many other possible modifications and variations can be made without departing from the spirit and scope of invention as hereinafter claimed.

What is claimed is:

1. A garden sprinkler securing structure comprising: two base members, one of the base members having an input opening and an output opening, the input opening configured to connect to a water source, the output opening provided with a sprinkler pivoted between the two base members; wherein water from the water source enters the input opening to drive the sprinkler to repeatedly swing between the base members; the two base members respectively further have two supporting legs opposite sides, a bottom side of each supporting leg engaging with a connecting member, the connecting member pivoted with a grounding nail, and wherein:
an outer side of each supporting leg of the base members is provided with a containment space at a bottom side, the containment space is configured for accepting the engaged connecting member; and the connecting member is provided with a slot having a pivoted grounding nail.

2. The garden sprinkler securing structure as claimed in claim 1, wherein the two base members are integrated.

3. The garden sprinkler securing structure as claimed in claim 1, wherein each supporting leg extends and tilts down from the base member.

4. The garden sprinkler securing structure as claimed in claim 1, wherein each supporting leg extends from the base member horizontally.

5. The garden sprinkler securing structure as claimed in claim 1, wherein the containment space further has a positioning member disposed at two sides of the connecting member, for securing the connecting member in the containment space.

6. The garden sprinkler securing structure as claimed in claim 1, wherein the connecting member is stored in the containment space and then locked with the containment space.

7. The garden sprinkler securing structure as claimed in claim 1, wherein the slot further has at least one supporting member for securing the grounding nail.

8. The garden sprinkler securing structure as claimed in claim 1, wherein the grounding nail has a sharp end and a protruding strip.
